(19) United States
(12) Patent Application Publication
(10) Pub. No.: US 2015/0206064 A1
(43) Pub. Date: Jul. 23, 2015

(54) Method for supervised machine learning

(71) Applicant: Jacob Levman, Toronto (CA)

(72) Inventor: Jacob Levman, Toronto (CA)

(21) Appl. No.: 14/158,841

(22) Filed: Jan. 19, 2014

(51) Int. Cl. G06N 99/00

(52) U.S. Cl. CPC G06N 99/005

(57) ABSTRACT

A method for solving the supervised machine learning problem. A supervised machine learning algorithm is provided with training examples and is capable of classifying new measurements as belonging to one of the groups it was trained on. The proposed supervised learning technique has a single parameter controlling the test's bias in favour of one of the groups it was trained on. The technique can be used to solve a wide array of problems.

### FIELD OF THE INVENTION

This invention is directed to machine learning/artificial intelligence, an application of computer systems.

### BACKGROUND OF THE INVENTION

The methodology proposed in this patent is to be executed in a computer system. The method proposed is intended to provide an analytic computation that can be useful in solving the supervised learning problem where a computer is provided with examples of data from multiple groups and is tasked with assigning group values to new samples. Supervised learning systems are used in a wide variety of applications including computer-aided detection systems from medical images, automated analysis of satellite images and text and speech recognition software.

### BRIEF SUMMARY OF THE INVENTION

The following invention is a computational method intended to provide a solution to the supervised learning problem whereby a computer is provided with example training samples from multiple groups and is tasked with assigning new samples as belonging to either group. The proposed method presented benefits from a formulation that employs a single parameter to control test biasing, resulting in an easy-to-use technique for solving the supervised learning problem.

### BRIEF DESCRIPTION OF THE DRAWINGS

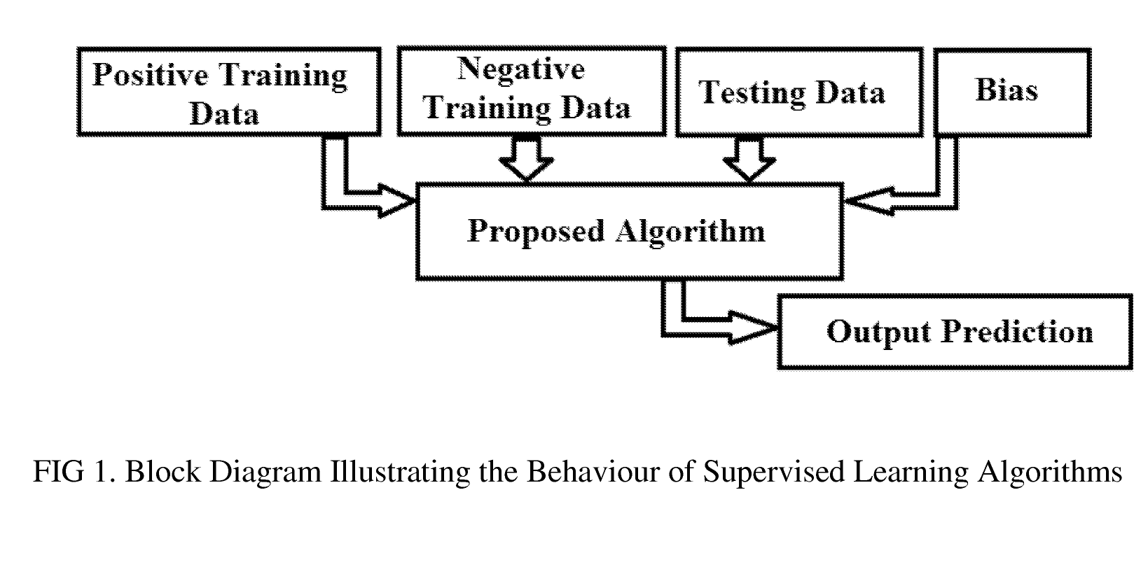

The invention is executed by computer. The reader's understanding of the supervised learning method proposed will benefit from FIGS. 1, 2 and 3.

### DETAILED DESCRIPTION OF THE INVENTION

This invention embodies a data processing methodology to be executed by computer or application specific integrated circuit. The computer algorithm is provided with example measurement sets of a known group of interest (the positive group) as well as example measurement sets of a different group (the negative group). The algorithm's main parameter controls test biasing. This alpha biasing parameter allows the user to control how likely the algorithm is to assign a test sample to either group. The algorithm is provided with test samples and assigns those samples as either members of the positive or negative training groups provided.

The algorithm defined above is designed to take in training and testing data and outputs a class value of +1 or −1 depending on whether the algorithm assigns the test sample to the positive or negative training group.

In one embodiment of the invention the algorithm is used to automatically refine edges between neighbouring groups as part of an automated image segmentation program. An automatic image segmentation algorithm divides an image into constituent segments, typically for further processing such as regional analyses.

In another example embodiment of the invention the technique is used to create regions-of-interest on images in a semi-automatic fashion. An example of this type of embodiment of the invention would be a system that allows a radiologist viewing medical images to quickly draw a circle around tissue of interest and a second circle around background tissue that they are not interested in. The algorithm then refines the edges of the tissue of interest by comparing each local pixel value(s) as an example test vector. The pixel locations that are assigned to the tissue-of-interest group are highlighted for the radiologist's inspection and would potentially proceed to further region-wide measurements of the tissue-of-interest.

In another embodiment of the invention the algorithm is used to perform computer-aided detection or diagnosis. The algorithm is provided with a set of previous measurements from diseased and normal tissues acquired from a biomedical data gathering device (such as a medical imaging system). The algorithm is then presented with new medical examinations and assigns the sample to one of the groups on which the algorithm was trained. Examples of this manifestation include a computer-aided detection system for breast cancer from any type of medical examination, or a system to identify infarcted tissues from any type of imaging examination.

In another embodiment of the invention the algorithm is implemented in a dedicated application specific integrated circuit (ASIC). The circuit is provided with example data and implements the proposed algorithm on a video stream to identify cancerous lesions from the data acquired in a pill camera.

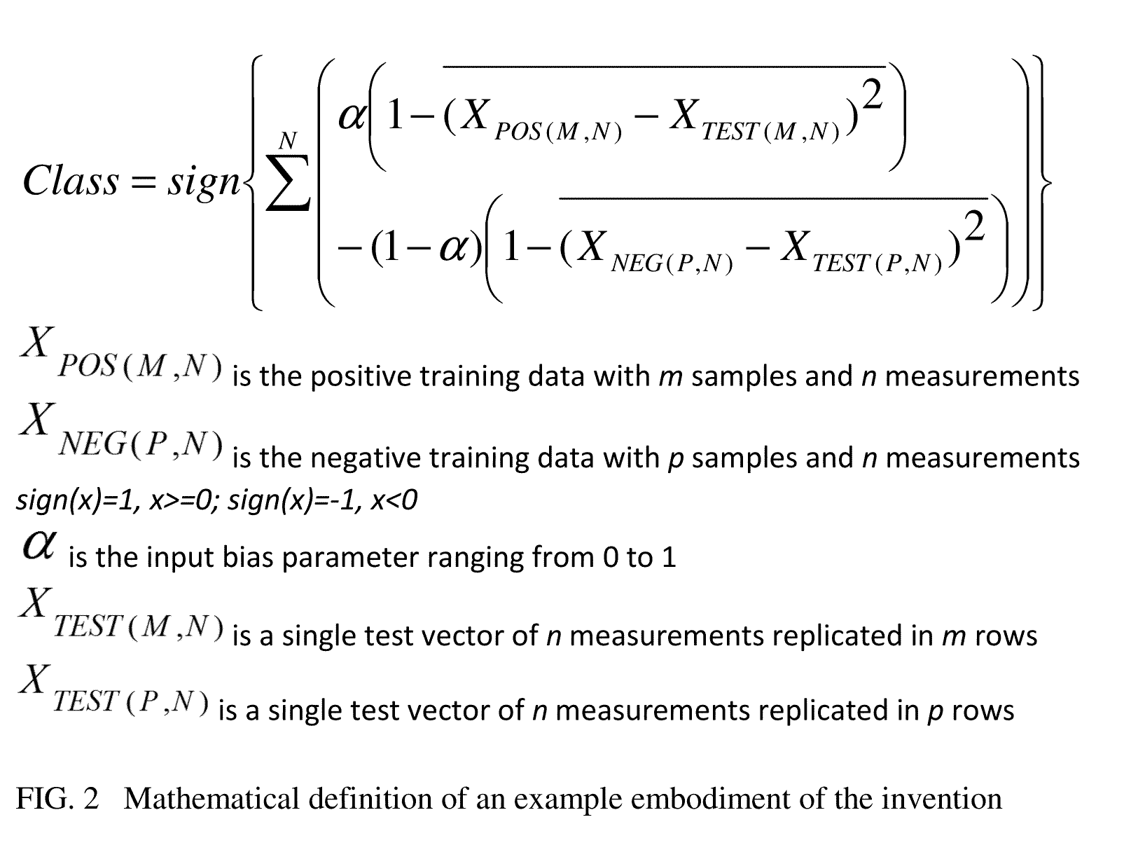

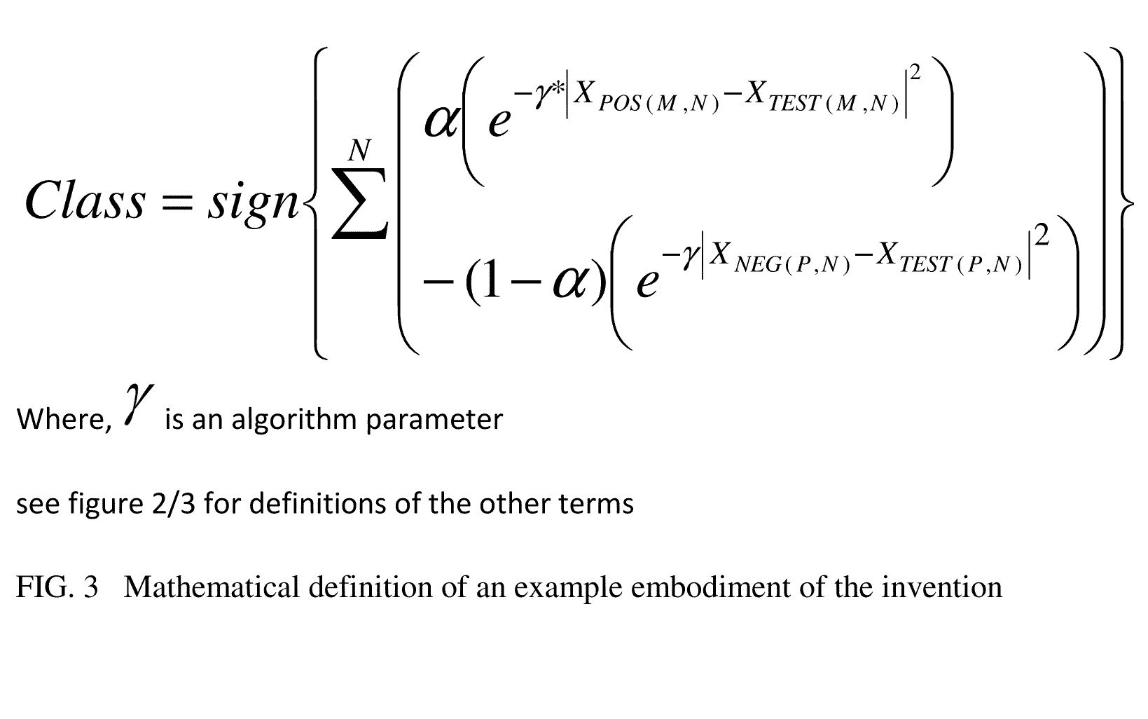

In another embodiment of the invention the sign term in the equations in FIG. 2 or FIG. 3 is removed so that instead of producing +1 and −1 prediction values, the algorithm outputs a range of unidimensional measurements. These unidimensional measurements form a custom index based on the training samples provided. Such a system could have clinical utility in patient outcome prediction as the index produced by the algorithm is demonstrated to be highly correlated with patient survival or another important clinically relevant end point. Images of this unidimensional combined measurement are displayed for clinical interpretation.

In another embodiment of the invention the sigma term (which is used to sum across the measurements) is replaced with a voting system allowing the algorithm to be sensitive to each individual measurement. These voting results could, for example, be used to refine the edges of naturally occurring red-green-blue (RGB) image to identify subtle boundaries between adjacent groups in a natural scene.

Computer code is also provided as an example embodiment of the invention. This software is authored in Matlab.

function [prediction]=SL(trainingSetPositive,trainingSetNegative,testVector,alpha);

| %%%%%%%%%%%%%%%%%%%%%%%%%%%%%%%%%%%%%%%%% | |
|---|---|
| %Function Notes: | |
| %Training and testing data should be scaled in the 0 to 1 range | |
| % | |
| % Input arguments | |
| % trainingSetPositive is a 2D array with n rows with p measurements | |
| % trainingSetNegative is a 2D array with m rows with p measurements | |
| % testVector is a single vector with p measurements | |
| % alpha is a user input parameter that controls the test's bias in | |
| % | favour of either group (range 0 to 1) |

| % | |
|---|---|
| % Output | |
| % | |
| % prediction =+1 if test Vector is assigned to the positive group | |
| % | −1 if test Vector is assigned to the negative group |

%%%%%%%%%%%%%%%%%%%%%%%%%%%%%%%%%%%%%%%%%
trainingSetPositive=double(trainingSetPositive);
trainingSetNegative=double(trainingSetNegative);
testVector=double(testVector);
positiveSetSize=size(trainingSetPositive,1);
negativeSetSize=size(trainingSetNegative,1);
testVectorArrayPositive=repmat(testVector,[positiveSetSize 1]);
testVectorArrayNegative=repmat(testVector,[negativeSetSize 1]);
negativeComponent=trainingSetNegative−testVectorArrayNegative;
negativeComponent=negativeComponent.*negativeComponent;
positiveComponent=trainingSetPositive−testVectorArrayPositive;
positiveComponent=positiveComponent.*positiveComponent;
positiveComponent=mean(positiveComponent);
negativeComponent=mean(negativeComponent);
positiveComponent=(1−positiveComponent);
negativeComponent=(1−negativeComponent);
temp=alpha*positiveComponent−(1−alpha)*negativeComponent;
predictionFloat=sum(temp);
if(predictionFloat >= 0)

prediction=1;

else

prediction=−1;

end

return;

The invention claimed is:

1. A method for the processing of grouped data so as to assign a new sample to one of the provided groups using the specified description (see mathematics equations, example computer listing and description) which provides an easy-to-use solution to the supervised learning problem.
